(19) United States
(12) Patent Application Publication
(10) Pub. No.: US 2009/0300594 A1
(43) Pub. Date: Dec. 3, 2009

(54) SYSTEM AND METHOD FOR CONTENT REPLACEMENT

(75) Inventor: Leonid Kozhukh, Palo Alto, CA (US)

Correspondence Address: PERKINS COIE LLP, P.O. BOX 1208, SEATTLE, WA, 98111-1208, US

(73) Assignee: ELEPHINO, INC., Palo Alto, CA (US)

(21) Appl. No.: 12/132,502

(22) Filed: Jun. 3, 2008

(51) Int. Cl. G06F 9/44

(52) U.S. Cl. 717/168

(57) ABSTRACT

In accordance with the techniques disclosed herein, a system and method remove undesirable content from original data. A unit of code interpretable to display a unit of content can be replaced with replacement code interpretable to display an alternative unit of content, or no content at all. Advantageously, a user need not view undesirable content. For example, advertisements included in a web page can be removed and/or replaced.

### BACKGROUND

A system providing content, such as via a website, transmits text, images, and other forms of content as data files including code. The code can be interpreted to display the intended website to a user including content pieces. The system typically presumes that a user device will not modify the code prior to displaying content. As such, the system often includes undesirable content—advertisements, persuasive messages, and distracting animation—along with the desirable information. The undesirable content may or may not be related to the desirable content.

Systems providing content typically presume that a user is powerless to control the data. Owners or operators of such systems are relatively free to sell content space, for example to advertisers. The advertisers presume that the individuals will request that the system providing content transmit both the undesirable content and the desirable content to the individual. Such an individual is presumed to view the undesirable content along with the desirable content. Such advertisers hope that the individuals will act on the undesirable content, for example, by purchasing goods and services associated with the undesirable content, voting for a candidate, changing behavior in accordance with a message, or taking other action.

However, desirable and undesirable data are typically stored on an individual user's computer. Individuals can program, or install programs to configure, customize and modify data stored on their individual systems. A user is not forced to view undesirable content.

The foregoing examples of the related art and limitations related therewith are intended to be illustrative and not exclusive. Other limitations of the related art will become apparent upon a reading of the specification and a study of the drawings.

### SUMMARY

The following examples and aspects thereof are described and illustrated in conjunction with systems, tools, and methods that are meant to be exemplary and illustrative, not limiting in scope. In various examples, one or more of the above-described problems have been reduced or eliminated, while other examples are directed to other improvements.

A technique for removing undesirable content identifies a unit of code interpretable to display a unit of content and replaces the unit of content with replacement code. The replacement code can be interpreted to display an alternative unit of content. The result is output data that can be provided to a user interaction interface for display to a user.

Advantageously, a user need not view undesirable content. For example, advertisements can be identified and removed for the user prior to the user viewing the content. A user experience is improved to the extent that the user can view the desirable content free from undesirable content.

A method implementing the techniques discussed above can include receiving original data including a unit of code interpretable to display a unit of content, identifying the unit of code within the original data by identifying a known segment of the code, performing an action to insert replacement code into the original data to replace the unit of code to create output data and providing the output data to a user interaction interface.

In a system operating in accordance with the technique described above, a content replacement engine coupled to a user interaction interface can receive a unit of data including a unit of code interpretable to display a unit of content. The unit of code can be replaced with a unit of replacement code to create output data. The output data can be provided to the user interaction interface for display to a user.

For a computer readable medium implementing the techniques discussed above, the computer readable medium can include a content replacement engine operable to receive one or more units of original code. The one or more units of original code can be interpretable to display an advertisement to an individual. The content replacement engine can be operable to replace at least a portion of the original code with a unit of replacement code interpretable to display content without including undesirable content.

### BRIEF DESCRIPTION OF THE DRAWINGS

FIG. 1 depicts a diagram of a content replacement engine coupled to an original data provider and a user device.

FIG. 2 depicts a diagram of components included in a content replacement engine.

FIG. 3 depicts a flowchart of a method for providing output data to a user interaction interface.

FIG. 4 depicts multiple diagrams of various configurations of a content replacement engine with a user interaction interface.

FIG. 5 depicts a flowchart of a method for replacing code interpretable to display undesirable content for a particular case of FIG. 4A.

FIG. 6 is a high-level block diagram showing an example of the architecture of a processing system that can be representative of any of the processing systems discussed herein, such as system for pricing advertising space.

### DETAILED DESCRIPTION

In the following description, several specific details are presented to provide a thorough understanding. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein.

In accordance with the techniques introduced above, a content replacement engine removes code interpretable to display undesirable content. The code can be, at times, removed, or alternatively, the code can be replaced with code interpretable to display desirable content. For example, advertisements can be removed from a web page returning only the desirable content. Advantageously, users enjoy an improved experience free from undesirable content.

As used herein, an “engine” includes a processor coupled to a computer readable medium storing instructions for execution by a processor. A “compute readable medium” is defined as any known or convenient machine, article of manufacture, or composition of matter capable of storing instructions for execution by a processor.

As used herein, a “user interaction interface” is a software program or system operable to interpret code and display content to a user. The user interaction interface can receive user input and responsively interpret the user input.

As used herein, a “plug-in” is a unit of software interoperable with a user interaction interface operable to access memory locations used by a user interaction interface and to store, retrieve, and modify data stored therein. The plug-in may or may not share memory space with the user interaction interface.

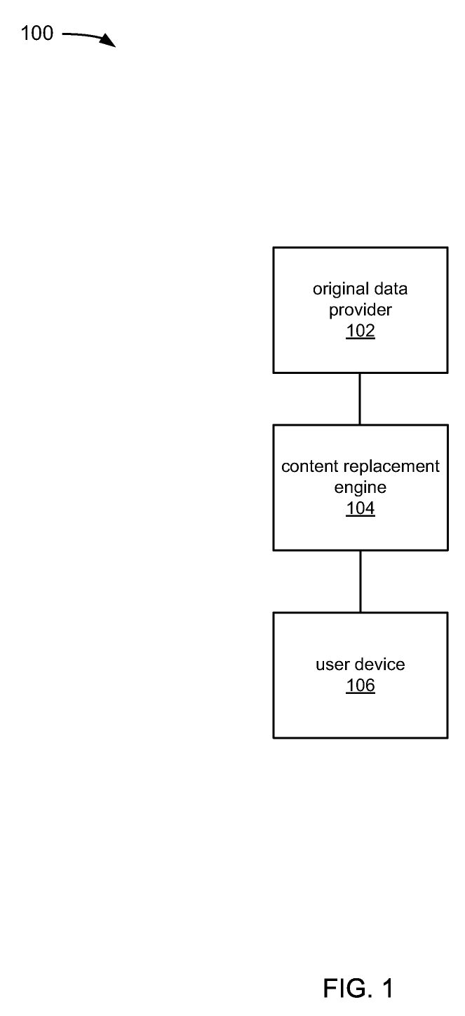

FIG. 1 depicts a diagram 100 of a content replacement engine coupled to an original data provider and a user device. FIG. 1 includes original data provider 102, content replacement engine 104, and user device 106.

In the example of FIG. 1, the original data provider 102 can be any computing system operable to provide content. For example, the original data provider 102 can be a server class computing system, a workstation adapted to transmit data, an embedded system transmitting data, a special purpose computing system, or any known or convenient device for transmitting original data including code interpretable to display a unit of content.

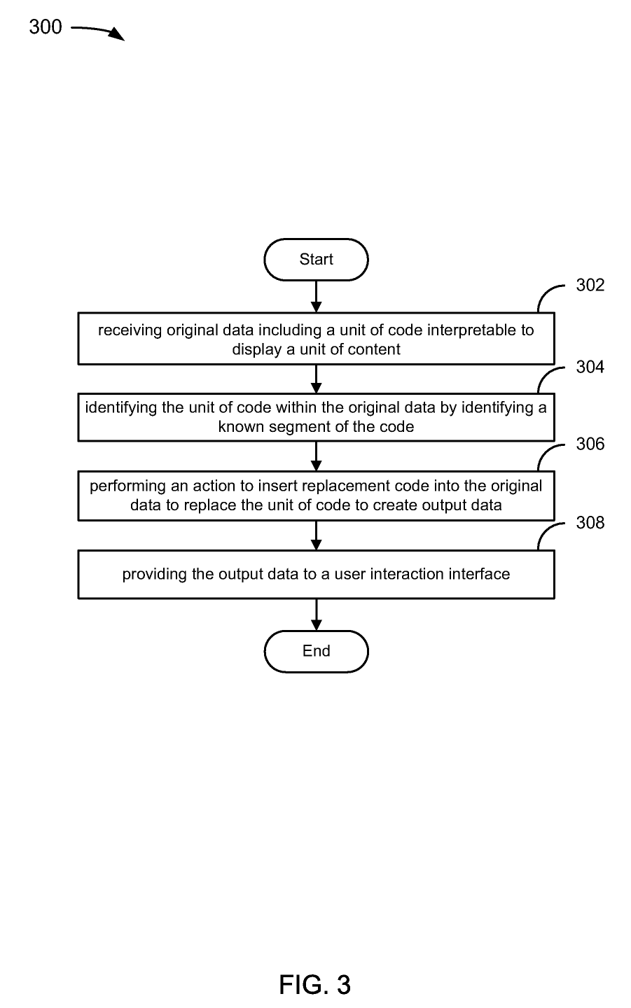

In the example of FIG. 1, the content replacement engine 104 can include a plug-in, a software module, a specially purposed computer, a server class computing device, an embedded system, any combination of the foregoing devices, or any known or convenient system for replacing code interpretable to display a unit of content with code interpretable to display alternative content. The content replacement engine 104 can operate on more than one computing device, where the computing devices are networked or otherwise coupled together. In some configurations, such as are discussed in reference to FIG. 3, the content replacement engine 104 can be included in the user device 106.

In the example of FIG. 1, the user device 106 can be any computing device operable to interpret a unit of code to display a unit of content. For example, the user device 106 can be a workstation, laptop, pda, or other known or convenient computing device.

In the example of FIG. 1, in operation, the original data provider 102 produces a unit of original data including a unit of code interpretable to display a unit of content. The original data provider 102 transmits the original data to the user device 106. The content replacement engine 104 intercepts the original data en-route to the user device 106 and identifies the unit of code within the original data by identifying a known segment of the code. The content replacement engine performs an action to insert replacement code into the original data to replace the unit of code to create output data. The content replacement engine 104 then transmits the output data to the user device 106 at which a user interaction interface interprets the output data to display content to a user without displaying the unit of content.

If desired, the replacement code can indicate alternative content to display. Alternatively the replacement code can include a null value. Where a null value is used, the unit of code can be deleted without inserting alternative replacement code.

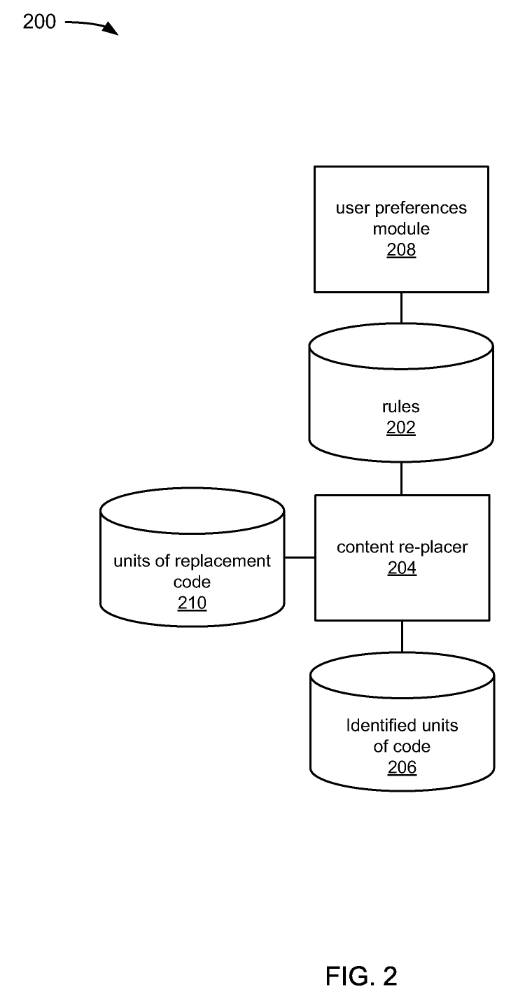

FIG. 2 depicts a diagram 200 of components included in a content replacement engine. FIG. 2 includes rules 202, content replacement module 204, identified units of code 206, and user preferences module 208.

In the example of FIG. 2, the rules 202 include records relating units of code to actions, for example, delete or replace. In a non-limiting example, a rule can be, replace code interpretable to display content A with code interpretable to display content B. Such a set of rules can be established for a set of units of identified code interpretable to display corresponding units of content.

In the example of FIG. 2, the content re-placer 204 includes instructions executable to replace a unit of identified code with replacement code. The content re-placer 204 can be embodied in a computer readable medium, specially purposed hardware, an embedded system, or any known or convenient device or system. The content re-placer 204 can be used to implement a content replacement engine.

In the example of FIG. 2, the identified units of code 206 can include records in a data store, database, file, or any other known or convenient manner or system of storing relationships. The identified units of code 206 can store records identifying features, tags, segments or other known or convenient identifiers of code for comparison to identify the code.

In the example of FIG. 2, the user preferences module 208 collects user preferences and creates rules and stores the rules in the rules 202. One or more rules could be derived from a single preference. The preferences can be used to determine how to respond to identified units of code. An individual user preference can relate an individual unit of code to an action for replacing the code.

In the example of FIG. 2, the units of replacement code 210 store units of code interpretable to display, typically, desirable content. The replacement code 210 can, at times, store alternative units of undesirable code. The replacement code 210 can store a null value as a unit of replacement code for use in removing a unit of code and replacing the unit of code with nothing.

In the example of FIG. 2, in operation, the content re-placer 204 receives original code including a unit of code interpretable to display a unit of content. The content re-placer identifies the unit of code by comparing the original code, or fractions thereof with the identified units of code 206. Where a match is found, the content re-placer checks the rules 202 for a rule to use in handling the code. Using the preferences a rule from the rules 202 is selected and the content re-placer 204 replaces the units of code with units of code from the units of replacement code 210.

FIG. 3 depicts a flowchart 300 of a method for providing output data to a user interaction interface. The method is organized as a sequence of modules in the flowchart 300. However, it should be understood that these and modules associated with other methods described herein may be reordered for parallel execution or into different sequences of modules.

In the example of FIG. 3, the flowchart begins at module 302 with receiving original data including a unit of code interpretable to display a unit of content. The original data can be interpretable to display content to a user. The unit of content can be undesirable, for example, an advertisement.

In the example of FIG. 3, the flowchart continues to module 304 with identifying the unit of code within the original data by identifying a subset of transmitted code. Identified units of code can be compared with the original data to identify the unit of code. The code can be replaced or ignored, depending on either a user's preference.

In the example of FIG. 3, the flowchart continues to module 306 with performing an action to insert replacement code into the original data to replace the unit of code to create output data. The portion of the original data that is replaced with the replacement code can be deleted, such as to display nothing in the place of the unit of content.

In the example of FIG. 3, the flowchart continues to module 308 with providing the output data to a user interaction interface. The user interaction interface will interpret the output data and display content to a user.

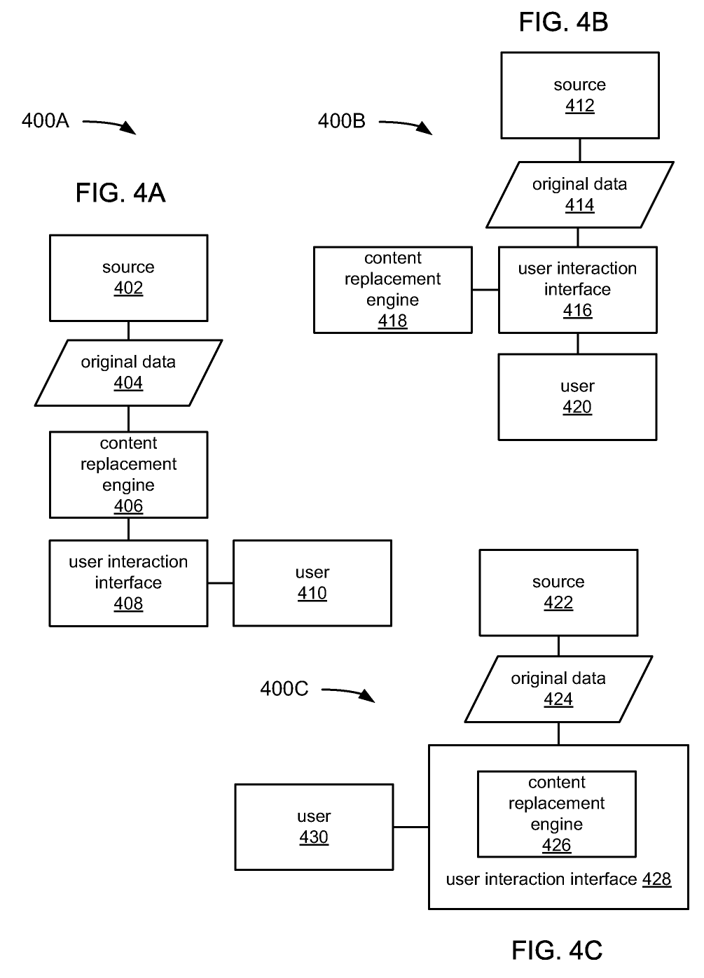

FIG. 4 depicts multiple diagrams 400A, 400B, and 400C of various configurations of a content replacement engine and a user interaction interface. FIG. 4A includes source 402, original data 404, content replacement engine 406, user interaction interface 408, and user 410. In the example of FIG. 4A, content replacement engine 406 is depicted between source 402 and the user interaction interface 408. There, the original data is modified by the content replacement engine 406 prior to reaching the user interaction interface 408.

FIG. 4B includes source 412, original data 414, user interaction interface 416, content replacement engine 418, and user 420. In the example of FIG. 4B, the content replacement engine 418 sits behind the user interaction interface 418. In the example of FIG. 4B, in operation, the user interaction interface receives the original data 414, and provides the original data 414 to the content replacement engine 418. The content replacement engine 418 then modifies the original data, for example, replacing code, to create output data and provides the output data to the user interaction interface 416. The user interaction interface 416 then interprets the output data and displays content to the user 420.

FIG. 4C includes source 402, original data 404, user interaction interface 428, content replacement engine 426, and user 430. The content replacement engine 426 sits inside of the user interaction interface 428. In the example of FIG. 4C, in operation, the source 422 transmits original data 424 to the user interaction interface 428. The content replacement engine 426 modifies the original data to create output data. As the content replacement engine is a part of the user interaction interface 428, the content replacement engine 426 may, for example, have direct access to memory locations used by the user interaction interface 428. Once modified, the user interaction interface 428 interprets output data and displays content to the user 430.

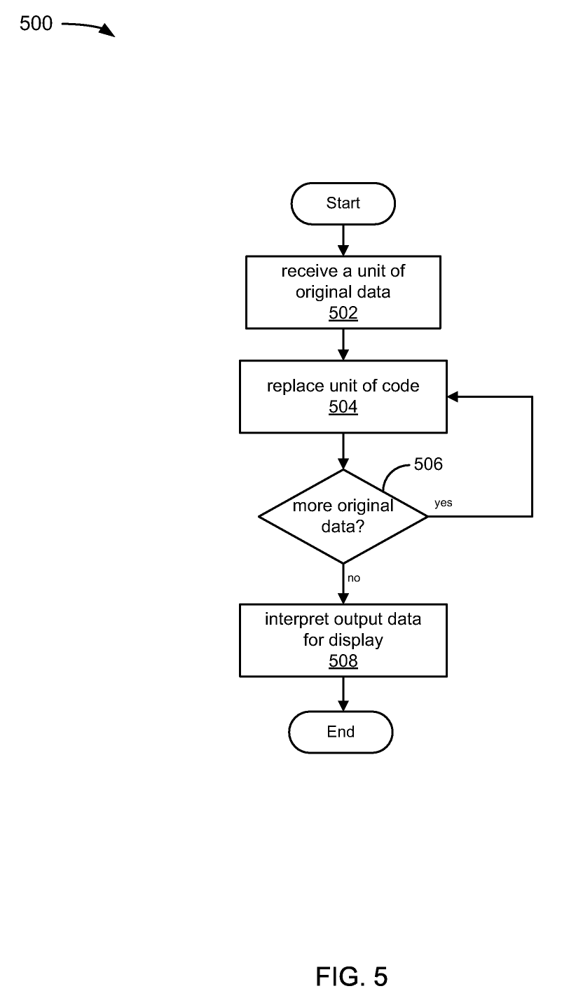

FIG. 5 depicts a flowchart of a method for replacing code interpretable to display undesirable content. The method is organized as a sequence of modules in the flowchart 300. However, it should be understood that these and modules associated with other methods described herein may be reordered for parallel execution or into different sequences of modules.

In the example of FIG. 5, the flowchart starts at module 502 with receiving a unit of original data. The original data can include one or more units of code interpretable to display units of content. The units of content can be, for example, undesirable advertisements.

In the example of FIG. 5, the flowchart continues to module 504 with replacing a unit of code. The unit of code can be replaced as described above or can be deleted, such as by replacing the unit of code with nothing to prevent the display of undesirable content.

In the example of FIG. 5, the flowchart continues to determination module 506 with deciding: is there more original data? For multiple units of code in original data, remaining units of code can be replaced as well. In this way multiple units of code can be replaced to prevent the display of multiple undesirable units of content.

In the example of FIG. 5, if the decision at module 506 is yes, the flowchart loops to module 504. Alternatively, if the decision at module 506 is no, then the flowchart continues to module 508 with interpreting output data for display. Having interpreted output data for display, the flowchart terminates.

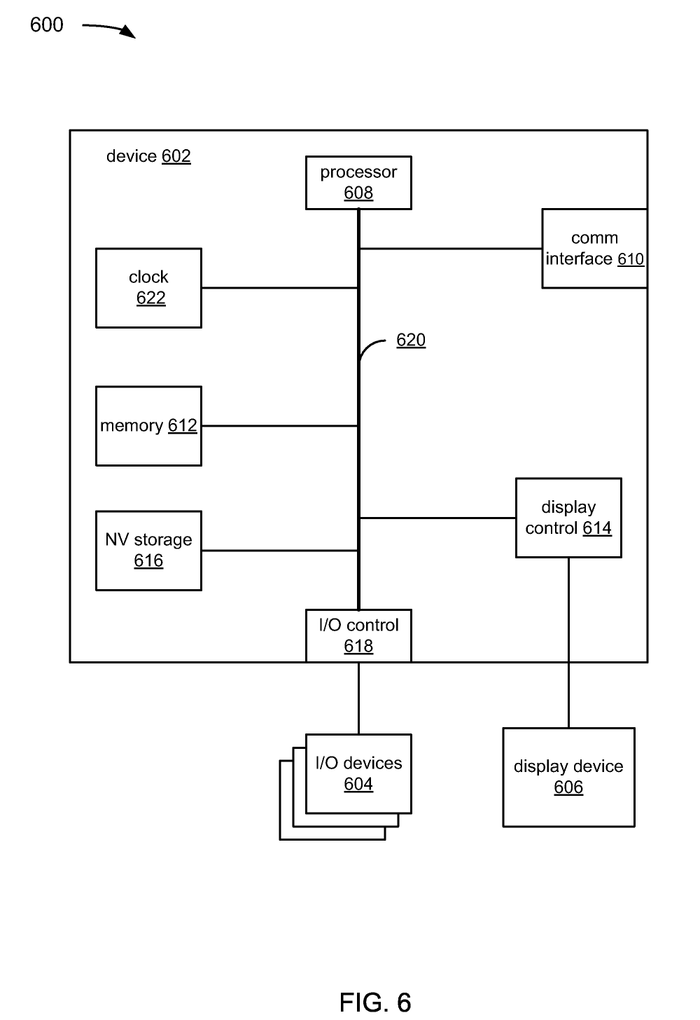

FIG. 6 is a high-level block diagram showing an example of the architecture of a processing system that can be representative of any of the processing systems discussed herein, such as system for pricing advertising space. The system 600 may be a conventional computer system that can be used as a client computer system, such as a wireless client or a workstation, or a server computer system. The system 600 includes a device 602, I/O devices 604, and a display device 606. The device 602 includes a processor 608, a communications interface 610, memory 612, display controller 614, non-volatile storage 616, I/O controller 618, clock 622. The device 602 may be coupled to or include the I/O devices 604 and the display device 606.

The device 602 interfaces to external systems through the communications interface 610, which may include a modem or network interface. It will be appreciated that the communications interface 610 can be considered to be part of the system 600 or a part of the device 602. The communications interface 610 can be an analog modem, ISDN modem or terminal adapter, cable modem, token ring IEEE 802.5 interface, Ethernet/IEEE 802.3 interface, wireless 802.11 interface, satellite transmission interface (e.g. “direct PC”), WiMAX/IEEE 802.16 interface, Bluetooth interface, cellular/mobile phone interface, third generation (3G) mobile phone interface, code division multiple access (CDMA) interface, Evolution-Data Optimized (EVDO) interface, general packet radio service (GPRS) interface, Enhanced GPRS (EDGE/EGPRS), High-Speed Downlink Packet Access (HSPDA) interface, or other interfaces for coupling a computer system to other computer systems.

The processor 608 may be, for example, a conventional microprocessor such as an Intel Pentium microprocessor or Motorola power PC microprocessor. The memory 612 is coupled to the processor 608 by a bus 620. The memory 612 can be Dynamic Random Access Memory (DRAM) and can also include Static RAM (SRAM). The bus 620 couples the processor 608 to the memory 612, also to the non-volatile storage 616, to the display controller 614, and to the I/O controller 618.

The I/O devices 604 can include a keyboard, disk drives, printers, a scanner, and other input and output devices, including a mouse or other pointing device. The display controller 614 may control in the conventional manner a display on the display device 606, which can be, for example, a cathode ray tube (CRT) or liquid crystal display (LCD). The display controller 614 and the I/O controller 618 can be implemented with conventional well known technology.

The non-volatile storage 616 is often a magnetic hard disk, flash memory, an optical disk, or another form of storage for large amounts of data. Some of this data is often written, by a direct memory access process, into memory 612 during execution of software in the device 602. One of skill in the art will immediately recognize that the terms “machine-readable medium” or “computer-readable medium” includes any type of storage device that is accessible by the processor 608.

Clock 622 can be any kind of oscillating circuit creating an electrical signal with a precise frequency. In a non-limiting example, clock 622 could be a crystal oscillator using the mechanical resonance of vibrating crystal to generate the electrical signal.

The system 600 is one example of many possible computer systems which have different architectures. For example, personal computers based on an Intel microprocessor often have multiple buses, one of which can be an I/O bus for the peripherals and one that directly connects the processor 608 and the memory 612 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 612 for execution by the processor 608. A Web TV system, which is known in the art, is also considered to be a computer system, but it may lack some of the features shown in FIG. 6, such as certain input or output devices. A typical computer system will usually include at least a processor, memory, and a bus coupling the memory to the processor.

In addition, the system 600 is controlled by operating system software which includes a file management system, such as a disk operating system, which is part of the operating system software. One example of operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 616 and causes the processor 608 to execute the various acts required by the operating system to input and output data and to store data in memory, including storing files on the non-volatile storage 616.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is Appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present example also relates to apparatus for performing the operations herein. This Apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, flash memory, magnetic or optical cards, any type of disk including floppy disks, optical disks, CD-ROMs, and magnetic-optical disks, or any type of media suitable for storing electronic instructions, and each coupled to a computer system bus.

The algorithms and displays presented herein are not inherently related to any particular computer or other Apparatus. Various general purpose systems may be used with programs in accordance with the teachings herein, or it may prove convenient to construct more specialized Apparatus to perform the required method steps. The required structure for a variety of these systems will appear from the description below. In addition, the present example is not described with reference to any particular programming language, and various examples may thus be implemented using a variety of programming languages.

What is claimed is:

1. A method comprising:
receiving original data including a unit of code interpretable to display a unit of content;
identifying the unit of code within the original data by identifying a subset of the code;
performing an action to insert replacement code into the original data to replace the unit of code to create output data; and
providing the output data to a user interaction interface.

2. The method of claim 1, wherein the replacement code has a null value indicating that the unit of code should be deleted.

3. The method of claim 1, further comprising identifying a source of the original data providing the one or more units of code.

4. The method of claim 1, further comprising retrieving a rule for replacing or removing the units of code.

5. The method of claim 1, wherein the rule is retrieved from user settings indicating a preference of a user for a particular type of content to replace the unit of content.

6. The method of claim 1, further comprising generating the action from a previously prepared set of criteria relating the units of code to a source of the unit of code.

7. A system comprising:
a content replacement engine; and
a user interaction interface coupled to the content replacement engine;
wherein, in operation,
the content replacement engine receives a unit of content including a unit of code interpretable to display a unit of content and replaces the unit of code with a unit of replacement code to create output data and provides the output data to the user interaction interface.

8. The system of claim 7, wherein the content replacement engine is included in the user interface engine and operates as a component of the user interface engine.

9. The system of claim 7, wherein the content replacement engine is coupled to the user interface engine logically in front of the user interface engine, receiving the unit of content prior to the user interaction engine.

10. The system of claim 7, wherein the content replacement engine is coupled to the user interface engine logically behind the user interface engine, and the content replacement engine first receives the unit of content and provides it to the content replacement engine.

11. A computer readable medium including instructions executable by a processor comprising:
a content re-placer operable to receive one or more units of original code including a unit of code interpretable to display an advertisement to an individual, the content re-placer operable to replace at least a portion of the original code with a unit of code interpretable to display content other than the advertisement.

12. The computer readable medium of claim 11, further comprising a database storing identified units of code including associated providers of the code for use by the content re-placer in identifying units of content to replace.

13. The computer readable medium of claim 11, further comprising a user preferences module operable to store a rule indicating a particular unit of content that a user would prefer to have displayed instead of the advertisement.

14. The computer readable medium of claim 11, further comprising a database storing a rule used by the content re-placer to replace a unit of code with a unit of replacement code.
